(19) United States
(12) Patent Application Publication
(10) Pub. No.: US 2010/0169204 A1
(43) Pub. Date: Jul. 1, 2010

(54) RETAIL DERIVATIVE FINANCIAL PRODUCTS

(76) Inventors: Bradford Sippy, North Wales, PA (US); Paresh Patel, Plymouth Meeting, PA (US)

Correspondence Address: BRADFORD C. SIPPY, P.O. Box 2014, Acton, MA, 01720, US

(21) Appl. No.: 12/663,277

(22) PCT Filed: Jun. 8, 2008
(86) PCT No.: PCT/US08/66230

§ 371 Date: Dec. 5, 2009

Related U.S. Application Data
(60) Provisional application No. 60/943,061, filed on Jun. 10, 2007.

(51) Int. Cl. G06Q 40/00

(52) U.S. Cl. 705/35

(57) ABSTRACT

The present invention describes the creation of derivative financial products such as options, futures, and other derivatives whereby the underlying asset of the derivative is based on a Third Party Data performance indicator, such as unit volume or market share, of one or more retail product(s). The invention further describes the creation of derivatives for retail products whereby non-investor consumers of retail products can participate in the market for said derivatives.

### BACKGROUND OF INVENTION

1. Copyright Notice

This document contains material that is subject to copyright protection. The applicants have no objection to the facsimile reproduction of this patent document, as it appears in the U.S. Patent and Trademark Office (PTO) patent file or records or in any publication by the PTO or counterpart foreign or international instrumentalities. The applicants otherwise reserves all copyright rights whatsoever.

2. Field of the Invention

The present invention relates to the creation of derivative financial products, such as futures and options, based on a third party data performance indicator of retail product(s) and services, such as unit volume or market share.

3. Description of Related Art

Derivative Securities and Derivative Financial Products Market Structure

A description of information relevant to the present invention, including information regarding derivative securities and the markets in which they are exchanged, is provided in U.S. patent application Ser. No. 10/358,647 by Sippy et al. and is incorporated herein by reference.

In addition to traditional derivative markets, several forms of non-traditional derivative markets/products have been developed in recent years. For example, The Iowa Electronic Markets, operated by the University of Iowa (www.biz.uiowa.edu), are real-money futures markets in which contract payoffs depend on economic and political events such as elections. Unlike stock or commodity derivatives, event based derivatives such as those traded on the Iowa Electronic markets are often structured as a set of futures whose “underlying assets” are differing outcomes of the same event.

These sets of futures are typically structured such that the payoff conditions of each derivative are mutually exclusive (e.g. the occurrence of any one of them automatically implies the non-occurrence of the remaining) These sets of derivatives are also often structured such that the payoff conditions of each derivative taken together are collectively exhaustive (e.g. at least one of the events must occur). For example, in a typical U.S. Presidential election, the futures the Iowa Electronic Market establishes are such that a payoff of $1.00 occurs if the resulting politician underlying a given future wins (e.g. Bush to win, Kerry to win). As there can be only one winner of a U.S. Presidential election and each future is for only one person, the futures are, by definition, mutually exclusive. However, the Iowa Electronic Market does not typically trade futures for all U.S. Presidential nominees, as trading volume and investor interest for low probability candidates do not justify establishing futures for those candidates. Therefore, technically the U.S Presidential futures contracts are not collectively exhaustive (though the probability of a minor party candidate winning in a general election is so low that having futures on the two main party candidates plus the largest third party candidate is effectively collectively exhaustive).

Like trading on an in-the-money option prior to its expiration, where the price of the option will converge to the difference between the strike price and the current price of the underlying asset, in event based futures, the future price will converge on the payoff for the contract as the probability of the outcome for the event occurring approaches 100%. Therefore, with the maximum payoff for each future at $1.00, the maximum rational price for each U.S. Presidential future is $1.00 and one will typically see the price of the varying futures converge to $1.00 or $0.00 as the outcome of the election is determined. By logical extension, the price of an event future prior to its expiration divided by the potential payoff for the event occurring is effectively the probability the market is assigning to that particular outcome for the event occurring.

When constructing a new derivative or sets of derivatives that are event based, the characteristics of being mutual exclusive and collective exhaustive are important. Several ways being mutually exclusive and/or collectively exhaustive aids in market liquidity are: 1) by making a related set of derivatives distinct and easily understood by the market and; 2) by creating the opportunity for arbitrage profits when the cumulative price of the set of derivatives differs from the payoff value of any one derivative (assuming a consistent payout across all derivatives in the set).

A further example of a non-traditional derivative market would be the Hollywood Stock Exchange. The Hollywood Stock Exchange (www.hsx.com) is a web-based, multiplayer game in which players use simulated money to buy and sell “shares” of actors, directors, upcoming films, and film-related options. An example of a product offered on the Hollywood Stock Exchange is a “stock” for a movie. HSX does an “IPO” for a movie stock prior to its release, and the price the stock trades at is reflective of the predicted cumulative total box office gross (typically in the U.S. and Canada) as reported by Exhibitor Relations (www.ercboxoffice.com) for the first four weeks of wide release. The movie stocks on HSX are then “cashed out” (e.g. marked to market) at the end of this period with the actual reported cumulative total box office gross as provided by Exhibitor Relations. The “cash” accumulated in players' accounts on HSX have no nominal value, but can be used as credits and redeemed to “purchase” items from the site (typically minimal value items such as a t-shirt or coffee mug).

A future type of non-traditional derivative market could eventually be developed within one or more of the many popular virtual worlds that currently exist on the internet. Virtual worlds, such as Second Life (www.secondlife.com) and Active Worlds (www.activeworlds.com) are interactive, simulated environments accessed by multiple users through an online interface. These virtual worlds enable members to create and participate in a user-defined world of general use in which people can interact, play, do business, and otherwise communicate. The commerce aspect of these virtual worlds could eventually lead to financial markets, including derivative markets.

General Description of Retail Products:

For purposes of the present invention, a Retail Product is any product or service purchased or consumed by an end user (e.g. consumer) where a third party, as opposed to the original manufacturer/producer, is the seller in a substantial portion (e.g. greater than or equal to 10%) of the transaction volume (e.g. dollars or units) of the product or service. Examples of typical Retail Products include, but are not limited to: movies (whether viewed at a theater, rented, or purchased), books, video games, TV shows, electronics, articles of clothing, clothing accessories, fragrances, appliances, OTC pharmaceuticals, prescription pharmaceuticals, and food.

General Description of Third Party Retail Product Data Sources:

Third Party Data is defined as any aggregation (projected or unprojected) of performance data (e.g. volume, dollars, units, prescriptions, viewings, downloads) for a Retail Product reported and/or aggregated by an entity or entities other than the original manufacturer/producer of the product.

Projected data is defined as any aggregation of Third Party Data whereby, prior to its reporting, some form of mathematical manipulation is conducted on the raw data with the intent of correcting for known systematic error in the raw data.

Unprojected data, conversely, is defined as any aggregation of Third Party Data whereby, prior to its reporting, no form of mathematical manipulation is conducted on the raw data with the intent of correcting for known systematic error in the raw data.

The distinction between Third Party Data for a Retail Product and self-reported performance data by the original manufacturer/producer is critical. First, Third Party Data is typically aggregated for both individual and related Retail Products (e.g. all movies in a particular geography) and therefore cross-class comparisons such as market share or performance to prior historic norms can be determined with data that is collected and aggregated in a consistent manner. Secondly, Third Party Data is typically available in a more timely and more frequently updated manner to the general market than self reported performance data. Finally, as Third Party Data is aggregated by an entity(ies) whose core business is the aggregation of such data and is sold to a wide variety of customers, it may be viewed as more robust and less open to manipulation or error (and may in some cases be available for auditing).

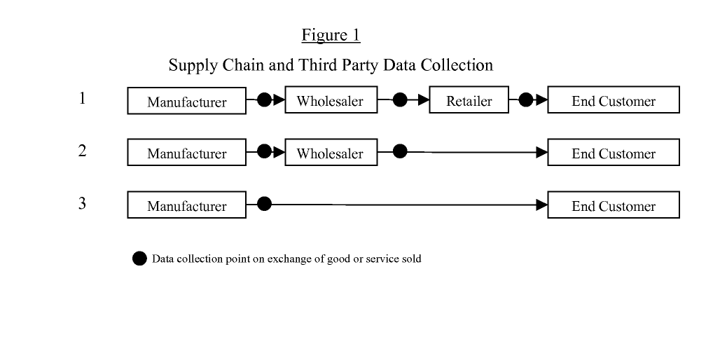

Third Party Data can be captured for most any transaction regardless of what stage in the distribution channel the product resides at any given time. Transactions between the manufacturer and the wholesaler, the wholesaler and the retailer, and the retailer and the end customer are all transactions where data collection can take place to measure the performance of the product or service (see FIG. 1—Supply Chain 1). In many instances end customers are able to purchase goods and services directly from the wholesaler or the manufacturer. (see FIG. 1—Supply Chain 2 & 3). Data collections can also take place with these transactions to measure a product's performance. The most important transactions to measure overall product performance will be those transactions with the end customer, regardless of the selling party. (FIG. 1—Supply Chain 1,2, & 3)

Examples of common Third Party Data sources are given below.

Prescription Pharmaceutical Data

A description of information relevant to the present invention, including information regarding the collection and reporting of prescription pharmaceutical data in the United States, is provided in U.S. patent application Ser. No. 10/358,647 by Sippy et al. and is incorporated herein by reference.

Scanner Data

One common Third Party Data source, collected via retail outlets such as grocery stores or department stores, is scanner data. Scanner data are electronic transaction records that are collected by an individual business as part of their normal operating procedures. The most common example is the scanning of bar codes from food items at a grocery store or from consumer goods at a retail outlet via a UPC symbol. When a bar code is scanned information on units, sale price, and volume of the purchase is recorded via the UPC symbol. The UPC symbol provides three pieces of information in a 12 digit numerical code: the vendor, the item number, and digit check number (used for quality control at the transaction level). Once the transaction is complete and the 12 digit numerical bar code is recorded using a scanner machine, the bar code information is electronically cross referenced to the retail outlet's database to capture a database record of attributes associated with the item number. Basic attributes include unit, volume and pricing information. Scanner data has several internal applications for a retail business, including totaling the sales of a customer visit, order management for additional stock to replenish goods sold, and measuring the success of a promotion.

In addition to being utilized by retail businesses to manage their on-going concerns, scanner data is purchased by data providers such as AC Neilsen and IRI from retail outlets, aggregated, and re-sold to Retail Product manufacturers/producers to manage their on-going businesses. For example, IRI aggregates their scanner data from 34,000 stores across the country and is able to collect data from 100% of the stores within a retail chain affiliation. IRI data is robust whereby census level data on purchasing habits are collected. When a customer wishes to purchase a 2 liter bottle of soda at the grocery store, the UPC code for that bottle of soda will be scanned at the register. The numeric code on the UPC code identifies the store or vendor selling the bottle of soda as well as the bottle of soda itself. This information is collected electronically. Given the nature of the electronic system for data collection, IRI is able to provide real time feedback on the performance of a product. The UPC code can also be cross referenced with a record on the seller's database to conduct further analyses such as promotional effectiveness and price sensitivity. The item number tracking the bottle of soda can further be cross referenced with other grocery stores to conduct further analyses, such as geographical performance across different stores in a given grocery chain. The UPC item number can further be aggregated with other UPC item numbers that are associated with the brand of soda to measure the overall performance of the brand. For example if only two sizes of lemon-lime “Sip Sip” soda existed, a 6 oz. and a 12 oz bottle, each bottle would have it's own unique UPC identifiers. The item numbers for the 6 oz. and 12 oz. can be aggregated together to measure the overall performance of “Sip Sip” soda. Further aggregation can also occur across retail outlets and retail chains whereby the overall performance of a brand in the nation can be measured.

Entertainment Industry

Third Party Data is utilized to track the performance of products in the entertainment industry (e.g. movie ticket sales, OnDemand and online rentals, TV show ratings, video rentals, video game purchases). Some of the reporting capability in this sector of the economy had originally been developed to support revenue sharing of entertainment product revenue between studios, distributors, actors, investors, etc. Vendors for such Third Party Data in the entertainment industry include Nielsen EDI (www.entdata.com) and Rentrak (www.rentrak.com).

Third Party Data for movie ticket sales provides an illustrative example of how such data for entertainment products is currently collected and utilized. Rentrak is a market research company whose activities include collecting and reporting data on box office ticket sales for feature films. Rentrak receives data electronically, ticket by ticket, seconds after each ticket sale from over 4,000, or nearly 80%, of U.S. theaters. This data is then provided to movie studios via a 24 hour a day, web-based, real-time system which is reported both in the aggregate and by multiple variables (e.g. by time, by geography, by type of theater). Nielsen EDI has similar reporting capabilities to Rentrak, but collects from 50,000 theaters in 14 countries to provide both U.S. and ex-U.S. theater ticket reporting.

As described in an Associated Press Article on Aug. 2, 2006 titled “Movie Openings: Behind the Box Office,” once data such as Rentrak's and Nielsen EDI's is obtained by the studios for their respective titles, the studios apply proprietary internal projection methodologies to these Unprojected data to obtain a projected box office gross number. These numbers are then provided by each studio to organizations such as Exhibitor Relations (www.ercboxoffice.com) which report them to major media outlets. As a result, the box office totals typically reported on any given Monday (see example as reported in Monday, Nov. 20, 2006 edition of the Wall Street Journal, page B8 titled “At the Box Office”) for movies from the prior weekend are Projected values independently provided to Exhibitor Relations by each individual original manufacturer/producer (e.g. movie studios) and have no immediate association with actual sales values reported by a studio in a financial report at a later date.

Another example of the use of Third Party Data in the entertainment industry is for measuring the viewing of television shows. As described on their website, Nielsen Media Research (www.nielsenmedia.com) measures the number of unique viewers or households tuned to a television program in a particular time period during a week. The amount of viewership, known as a Nielsen Rating or Cume Rating, is calculated by dividing the number of unique viewers or households of a particular program in the Nielsen panel by the total number of unique viewers/households in the panel. Nielsen selects their panel in each geographic market it tracks in order to be able to project the values obtained from the panel to the geography as a whole. This measuring and projection process results in a percentage, or Nielsen rating, for each program monitored by each geography for a given time period.

Third Party Data is also utilized to track the performance of radio airplay for the entertainment industry. The primary vendor for third party radio airplay data is Nielsen BDS. Nielsen BDS (www.bdsradio.com) is a market research company whose activities include collecting and reporting data on radio airplay for music from recording artists across North America. Nielsen BDS uses a digital pattern recognition technology to capture data for over 100 million songs annually across over 1,400 radio stations representing over 130 markets in the U.S. (including Puerto Rico) and 30 Canadian markets. Nielsen BDS also monitors a variety music video channels in U.S and Canada. Nielsen BDS tracks data on a variety of music formats. Some examples include but are not limited to Adult Alternative, Adult Contemporary, Album Rock, Classic Rock, Contemporary Christian, Country, Modern Rock, Oldies, R&B, Spanish, and Top 40. This data is then provided via a 24 hour a day, web-based, real-time system which can be reported both in the aggregate and by multiple variables (by radio format, radio show, geography, etc.)

HitPredictor, a product from a music market research company Promosquad (www. Promosquad.com), performs online predictive music research with a large nationwide database of music listeners who rate songs, with results determining their “Hit” potential before they are released to the radio. Songs are blind tested online by another company Promosquad using multiple listens and a nationwide sample of carefully profiled music consumers. Songs are rated on a 1-5 scale; final results are based on weighted positives. Promosquad uses a an scoring system where songs with a score of 65 or more are judged to have “Hit” potential, although that benchmark number can fluctuate per format based on the strength of available music. Though not Third Party Data per se, HitPredictor data is often reported with radio Third Party Data from Nielsen BDS.

Data from both Nielsen BDS and Promosquad is supplied to music market research organizations such as Radio & Records (www.radioandrecords.com) that evaluates the performance of music over the U.S airwaves and the Canadian Music Network. Radio & Records distributes over 10,000 performance reports to various clients, which include record studios, radio stations, and producers. Songs are ranked based on airplay detections according to data provided weekly by Nielsen BDS and next to each song is listed the original “HitPredictor” score derived from Promosquad prior to the release of a music single.

As technology, and the means by which entertainment products are consumed, evolves, future means of tracking these activities via Third Party Data will be developed. For example, as described in a Sunday, Jun. 18, 2006 article by Reuters titled “Nielsen to track TV viewing on Web, mobile phones,” Nielsen plans to expand and enhance its traditional television ratings system to cover new means of viewing program content, such as viewing in public locations (e.g. bars, restaurants) and via alternate viewing devices (e.g. home computers, iPods).

Internet Retail Product Transactions

In addition, the internet provides a robust mechanism of tracking website traffic, advertising hits, and a host of other online activity. Companies like comScore Networks (www.comscore.com) are able to measure Internet usage, audience measurement, and provide e-commerce tracking data. As information technology evolves a Third Party Data provider, such as comScore, will evolve to track and measure Retail Product purchases that occur online over the Internet. Currently this type of data is only reported at the aggregate level (see comScore press release Nov. 16, 2006 titled “U.S. Online Apparel Spending Grows 32 Percent in the Third Quarter versus Year Ago.”)

### DETAILED DESCRIPTION

Problems in Related Art

Current financial instruments (stocks, bonds, options, futures, other derivatives, etc.) related to the entertainment and consumer goods industries represent aggregated performance of several, often large, Retail Product franchises. Unfortunately, this aggregation does not allow for a good measure of individual product performance. In the current state of financial services, investors who are bullish/bearish on the prospects of a particular company's product/service may act on those beliefs only indirectly via the purchase of stock of the company or option/futures of that stock, and only then if the company is publicly owned.

In the current art, sophisticated investors, such as hedge funds, as well as average investors, have little alternative when wanting to take an undiluted position in a Retail Product. As described in a page A1 article in the Apr. 29, 2006 edition of the Wall Street Journal titled “Defying the Odds, Hedge Funds Bet Billions on Movies,” hedge funds, when wanting to take an undiluted position in a Retail Product, choose to directly finance the creation of the Retail Product. Even this crude alternative is largely only available to financing of entertainment Retail Products such as movies, where outside financing is the norm, or start-ups created around a new Retail Product. Opportunities for taking an undiluted financial position in the success or failure of a product being brought to market by an existing company are generally limited.

Mukunya et al. recognizes this problem in the current art and describes a system to trade derivatives based on brand sales, focusing mostly on movies. Though a step forward from the prior art, there are limitations in this design. Limitations in Mukunya et al. that the present invention addresses include, but are not limited to, the following:
1) Mukunya et al describes an invention based on actual brand sales. Though obviously the most accurate representation of a retail products performance, actual sales values have a significant time lag associated with their reporting, and, if the company selling the product/service is private, may not ever be publicly reported. Additionally, even when reported, only high level information is usually provided (e.g. total sales, by broad geography for greater than or equal to a quarter at a time). Therefore, final settlement for these derivatives would be dependent on the reporting of actual brand sales, potentially having a significant lag associate with them. The present invention overcomes this limitation by utilizing Third Party Data, which is available in a more timely manner, to enable more classic pricing and mark to market functions of derivatives. This utilization of Third Party Data as the platform upon which to base derivatives is one reason the present invention is an unobvious improvement as it employs a previously un-suggested combination or two unrelated fields (financial products and Third Party Data industries) whereby a person having ordinary skill in the art (PHOSITA) of one field is unlikely to be aware of the other field, let alone sophisticated enough to know how to construct one (a financial product) utilizing the other (Third Party Data). Note that in the entire disclosure by Mukunya et al. (by definition someone qualifying as at least a PHOSITA in the case of financial products) not one mention is made of Third Party Data.
2) By utilizing Third Party Data, the present invention allows for the creation of more sophisticated derivatives which require data on similar products reported in a consistent fashion (e.g. market share, ratios of launch performance to historic norms). These more sophisticated derivatives are not described or anticipated by the prior art and would be much more difficult to create with actual brand sales for a variety of reasons (companies do not report sales on the same schedule, different geographic definitions are used, some retail sales may not be reported at all because the manufacturer is private, etc.)
3) In order to enable the trading of the derivatives described, Mukunya describes and claims a proprietary, custom trading system and a structure/settlement method utilizing pari-mutuel principles. The present invention describes derivatives that can be traded in the same manner as derivatives currently traded on standard exchanges and can have structures/settlement method similar to current derivatives base on intangible assets

An additional problem in the prior art, including Mukunya et al., is that current trading systems have inherent barriers to entry, especially when one wants to trade financial derivatives. These barriers (e.g. must establish trading account, minimum amount of capital required to trade, minimum knowledge of derivatives market generally required) preclude the participation of general consumers and non-sophisticated investors. Historically this has been of little concern, as the ability to participate in trading of derivatives available in the current art (e.g. derivatives whose underlying assets are based on common financial products such as stocks, bonds, commodities) was more or less proportional to the interest to trade the underlying asset. However, for Retail Derivative Financial Products, this correlation no longer holds, as many of the most informed and/or most interested persons in trading these types of derivatives may not be able to capitalize on that knowledge/interest because of the lack of ability to participate in classic derivative markets. For example, a 18-year old girl who is a knowledgeable consumer of fashion products may be very informed and interested in the prospects of a new style of blue jeans, but would very likely not be able to participate in the trading of derivatives as they are currently made available to investors.

The Hollywood Stock Exchange (HSX) also illustrates a significant representation of the current art, especially its “stocks” for movies. Unlike Mukunya and current derivative markets, HSX has somewhat lower barriers to participation in its “market” by non-sophisticated investors, as the manner in which the instruments are constructed are easier to understand and the “market” is essentially a multi-player game which does not involve actual currency. However, HSX relies on data reported by Exhibitor Relations as the underlying asset to its products. The data from Exhibitor Relations is merely collated data self-reported by movie studios, each with their own proprietary projection methodology, and therefore these products are not based on Third Party Data.

### SUMMARY OF INVENTION

The present invention describes the creation of financial products such as options, futures, and other derivatives whereby the underlying asset of the derivative is based on a Third Party Data performance indicator, such as unit volume or market share, of one or more Retail Product(s). In the current art there is no financial product or service that allows an investor to take an undiluted position in the performance of an individual Retail Product. Additionally, in the current art there is no financial product or service that allows an informed interested consumer of a Retail Product to capitalize on that interest and take a position in the success or failure of a Retail Product. The existence of: 1) Third Party Data for most individual Retail Product(s) or any combination thereof; 2) robust, standardized futures and options markets; 3) the ubiquitous utilization of electronic commerce (e.g. purchase over the internet or with electronic capture/interaction at a retail outlet); and 4) the success of options and futures based on intangible assets, can all be combined to address these problems.

Benefits of Invention

The current financial system provides only indirect ways for investors to take positions in the prospects of a specific Retail Product. As discussed previously, most Retail Products are owned and marketed by large companies whose total sales are composed of multiple products, or are owned by private companies. Therefore, taking a stock or derivative position in a company because of a direct interest in the success or failure of one particular product is, at best, an imperfect way to capitalize on that interest. In addition to allowing more direct exposure to the success or failure of a Retail Product for typical investors, the present invention provides the additional benefit of allowing access to derivative markets for non-traditional investors (e.g. typical consumers). The participation of non-traditional investors not only expands the scope of investors participating in the market, but also enhances the liquidity and accuracy of the pricing of the derivatives being traded.

### DETAILED DESCRIPTION OF PRESENT INVENTION

The present invention describes the creation of retail derivative financial products. Retail derivative financial products are derivatives based on existing standardized, continuous, rigorous, and widely available data sources specific to a particular Retail Product or group of products that allows investors to take financial positions that are directly related to the performance of a given product or groups of products. The present invention also includes retail derivative financial products and a method for trading specific to non-sophisticated investors interested in the Retail Products being traded.

The manner in which these Retail Derivative financial products are constructed is very similar to that of derivative financial products based on stock market indices. As previously described in U.S. patent application Ser. No. 10/358,647 by Sippy et al., financial derivatives can be defined by a set of common variables. The first is the underlying asset on which the derivative is based. The second is the exercise price, which is based on the value, price, quantity, etc. of the underlying asset. The third is a standard unit, which is the number of units of the underlying asset that each financial derivative represents. A final variable is the time of expiration (or expiration date). This variable puts an outer limit on the period of time in which the derivative financial product can be executed. Regardless of the type of financial derivative, each of these variables is necessary in order to define the product.

In the case of the present invention, the underlying asset, like that of an index option or future, is based on an intangible asset. In this case, the intangible asset is some form of a performance indicator for a Retail Product or group of products based on Third Party Data. Like an index option or index future, the exercise price is also based on the same intangible asset.

For the determination of the standard unit, different approaches are required for large numerical value performance indicators such as unit volume or sales volume vs. small numerical value performance indicators such as market share. In Retail Derivatives based on small numerical value performance indicators such as market share, there is a natural limit to the magnitude of the value of the underlying asset (e.g. between 0 and 100 for market share). Since the magnitude of the market share denomination is similar to that of many stock prices, the typical standard unit of 100 for stock options could be used. For unit volume ratio based derivatives, where the exercise price is based on the ratio of the unit volume for a given period to some prior period (previous month, same period previous year, etc.), the ratio is likely to be a small value (e.g between zero and 2) and so therefore a larger standard unit value could be utilized (e.g. 1000). For Retail derivatives based on large numerical value descriptions (which are typically cumulative in nature) such as unit or sales volume, in which the underlying asset will have larger magnitudes (e.g. millions of units per month) a standard unit of 1/1000 can be utilized in order to maintain reasonable potential valuation levels. Note that these standard unit values are arbitrary, could be structured in any number of ways, and must ultimately be interchangeable. For example, an investor who holds 1000 options with a standard unit of 1/100 has the same amount of financial exposure to the underlying asset of the option as if they held 10 options with a standard unit of 1 (assuming the same underlying asset, time of expiration, etc.). Therefore, the process and reasoning behind deciding an appropriate standard unit is similar to that made by public companies when pricing their initial public offering or undertaking a stock split, which centers on maintaining market liquidity. Though important to maintaining market liquidity of the assets, the actual value of standard units have little impact on the function of financial derivatives in general or on the Retail derivative financial products described herein.

Alternatively, one can choose to design fixed event based derivatives, whereby the payoff of the derivative is contingent upon the underlying asset reaching a certain value vs. directly relating the respective value of the underlying asset to the derivative via a standard unit.

For the time of expiration, any value more than one day greater than the date of issue could theoretically utilized, though in practice values greater than or equal to one month from the date of issue of the Retail derivative would be more practical and consistent with current financial derivative trading. Unlike most existing options and futures, Retail derivative financial products are a measure of performance over a given period of time. As such, implicit in the time of expiration is the beginning of the time period being measured (e.g. unit volume for the three months ending Mar. 31, 2003, for the first 12 weeks a product is commercially available).

The process of marking to market for retail derivative financial products could be similar to financial derivatives based on intangible assets. For a future, regardless of how it is related to the underlying asset, the trader's position could be marked to market on a daily basis against the futures price for the given contract at the end of the day. This is similar to the current method used for futures trading.

For options, actual volume based performance indicators are cumulative in nature and would be difficult to mark to market. Therefore, a system would need to be established whereby some measure available on an interim basis (daily or weekly market share, ratios of unit volume to historic comparables, average number of units for a given time period) would be utilized for marking to market purposes.

For options whose underlying asset is based on a calculated value of unit volume (such as the market share, ratios of unit volume to historic comparables, average number of units for a given time period, etc.), the options could be marked to market directly against the values calculated for an interim period.

Because interim performance indicators for Retail Products, such as daily or weekly unit market share, etc., are potentially more volatile than the longer time horizon measures such as monthly unit market share, rules would need to be established regarding how American style options (e.g. can be exercised anytime up to and including the time of expiration) would be managed and against what interim data points this would occur.

In addition to retail derivative financial products designed as individual, stand alone products, groups of such derivatives can also be constructed which may enhance the appeal of the products to both traditional and non-traditional investors. Much like the derivatives for presidential elections traded on the Iowa Electronic Market, sets of retail derivative financial products can be constructed where the underlying asset for each derivative is a differing performance outcome, alone or in relation to some standard comparator such as historic performance of similar product(s), of the same Retail Product. These sets of retail derivative financial products could be structured such that the payoff conditions of each derivative are mutually exclusive (e.g. the occurrence of any one of them automatically implies the non-occurrence of the remaining) These sets of derivatives could also be structured such that the payoff conditions of each derivative taken together are collectively exhaustive (e.g. at least one of the events must occur).

The benefits of structuring retail derivative financial products in mutually exclusive and/or collectively exhaustive sets are numerous. First, payoff conditions for these types of derivatives can be structured to be very easy to interpret for investors by employing, for example, binary outcome conditions (e.g. if underlying Retail Product achieves a certain level of performance relative to a historic comparison, then each derivative is worth $1.00, otherwise they are worth $0.00)

Second, the sets of derivatives can be offered to investors together, adding to the ease of understanding by having all potential outcomes represented at once. For example, a set of three mutually exclusive and collectively exhaustive derivatives for a particular Retail Product at its launch could be constructed; one where the product performs well in relation to historic comparisons (e.g. a “Blockbuster™”), a second where the product performs similar to historic comparisons (e.g. a “Punt™”), and a third where the product performs below historic comparisons (e.g. a “Bomb™”). In this case, an investor can, at one look, survey the potential derivatives for a Retail Product, determine how they inter-relate, and which matches the position they want to take.

Third, it is possible to design a set of mutually exclusive and/or collectively exhaustive derivatives such that the full spectrum of positions one could want to take on the outcome of a Retail Product (e.g. bullish, bearish, neutral) can be taken by being the buyer of a derivative in the set. This advantage is particularly important for enabling the trading of non-sophisticated investors. A major reason for the high barriers to entry for the trading of derivatives is to minimize the risk of contract non-performance. However, the risk of contract non-performance is generally concentrated in the seller of a particular derivative. By allowing a broad spectrum of positions to be taken from the buying side, the full participation in the market by non-sophisticated investors can be enabled without the burden of the high barriers to entry typical of other derivative markets. This opens up the opportunity for entirely new market situations. For example, it would be possible to construct derivative markets in which retail derivative financial products are offered for sale in retail settings such as at the point-of-sale for the original underlying Retail Product and purchased with standard means of payment (e.g. cash, credit card). Such a transaction would functionally be similar to the way warranties on durable goods (e.g. electronics) are currently offered for sale at the point of sale for durable goods.

Fourth, pre-arranged sets of mutually exclusive and/or collectively exhaustive derivatives aid in market liquidity by providing for the combination of various positions to take advantage of arbitrage opportunities that may occur when a price imbalance of one derivative develops relative to the other derivatives in the pre-arranged set. Sophisticated investors can identify when these price imbalances occur, develop trading positions to capitalize on the arbitrage profit available, and in developing their trading positions increase liquidity of the entire set of derivatives by the generation of the additional trades required to develop the arbitrage position.

The process of managing retail derivative financial products for standardized exchange trading would require a joint effort between an organization like the OCC and a standardized data provider (AC Neilsen, IRI, Rentrak, etc.) in order to set rules regarding a variety of issues including:
How to handle new products being introduced to the market. A suggested method would be to have a standardized procedure to announce in what market a new product would be defined at the time of a formal public announcement from the manufacture/producer about its development.
Standardized de-listing rules would need to be created to manage the life cycle of products. A suggested method would be to no longer trade products under 2% market share or after a given period of time.
Because third party performance data does have some amount of time lag associated with its availability (e.g. as little as a day in the case of box office ticket sales to several weeks in the case of scanner data), a standard set of timing of maturity of financial derivatives would need to be established. A suggested method would be to have derivatives expire at a set date such as the 3^{rd} Friday after the end of the measurement period for the derivative in question.
Occasionally, revisions of historic Third Party Data occur. Rules regarding how to handle these revisions would need to be established. A suggested method would be to have later revisions generated in the normal course of business for the Third Party Data provider ignored.
Rules regarding naming of the retail derivative financial products could be established in order to aid in recognition and understanding by investors. A suggested method would be to incorporate the brand name of the underlying Retail Product on which the derivative is based.
Rules regarding exercise price intervals, minimum tick sizes, etc. would be required and would vary depending on the unit of the underlying asset.

In addition to the above issues, retail derivative financial products that are offered for sale directly to consumers would have the below additional business issues to consider:
Regulatory challenges to the characterization of derivatives purchased by non-sophisticated investors as gambling versus investing could exist (either characterization would be within the scope of the present invention). In order to facilitate the characterization of derivatives purchased by non-sophisticated investors as investments (likely the more difficult status to obtain) a suggested method to achieve this end may include placing a cap on the number of derivatives, dollar amount, etc. that can be purchased by a given consumer at a given time, to limit financial exposure. The cap could vary depending on the method of payment for the derivative (e.g. payment via cash or debit card has a higher limit than payment via credit card) and whether a product in the category for which the derivative(s) are related was actually purchased.
The role of the retail outlet can vary considerably in the sale of retail derivatives. A suggested method would be to have two general categories: 1) Retail outlets that serve only as conduits of the transaction between the retail investor and a formal option exchange and are not a party to the transaction per se (“Conduit Vendor”). An example of such an arrangement in the current art would be a car dealer that sells an aftermarket warranty to a car purchaser, but is not contractually obligated for the performance of the warranty; and 2) Retail outlets that are the actual selling parties in, effectively, a secondary market transaction between the retailer and the purchaser.
Numerous derivations of the present invention can be constructed utilizing various forms of payment and payout including credit card payment, debit card payment, guaranteed funds payment (e.g. cash, money order, certified check), Paypal payment, non-cash loyalty currency (e.g. frequent flier miles), or payment via personal check.

The following aspects of the present invention are described, but not claimed.
A derivative financial product, wherein the Third Party Data performance indicator is an absolute measure of one or more Retail Product(s).
A derivative financial product, wherein the Third Party Data performance indicator is a relative measure of one or more Retail Product(s).
A derivative financial product, wherein the Third Party Data performance indicator is the sales volume of one or more Retail Product(s).
A derivative financial product, wherein the Third Party Data performance indicator is the unit volume of one or more Retail Product(s).
A derivative financial product, wherein the Third Party Data performance indicator is the volumetric volume of one or more Retail Product(s).
A derivative financial product, wherein the Third Party Data performance indicator is a ratio of unit volume to historic comparables of one or more Retail Product(s).
A derivative financial product, wherein the Third Party Data performance indicator is a ratio of volumetric volume to historic comparables of one or more Retail Product(s).
A derivative financial product, wherein the derivative financial product is structured as an option.
A derivative financial product, wherein the derivative financial product is structured as a future.
A derivative financial product, wherein the derivative financial product is structured as a future option.
A derivative financial product, wherein the derivative financial product is structured as an Asian option.
A derivative financial product, wherein the derivative financial product is structured as a barrier option.
A derivative financial product, wherein the derivative financial product is structured as a lookback option.
A derivative financial product, wherein the derivative financial product is structured as a currency-translated option.
A derivative financial product, wherein the derivative financial product is structured as a binary option.
A derivative financial product, wherein the exercising ability of the option functions as an American option.
A derivative financial product, wherein the exercising ability of the option functions as a European option.
A derivative financial product, wherein the exercise price is based on the Third Party Data performance indicator reaching a pre-determined level of performance relative to historic comparator(s) and the pre-determined level of performance is a set percentage of performance from 1 to 1000% above the performance of historic comparator(s).
A derivative financial product wherein the exercise price is based on the Third Party Data performance indicator reaching a pre-determined level of performance relative to historic comparator(s) and the pre-determined level of performance is a set percentage of performance from 1 to 99% below the performance of historic comparator(s).
A derivative financial product wherein the exercise price is based on the Third Party Data performance indicator reaching a pre-determined level of performance relative to historic comparator(s) and the pre-determined level of performance is a set percentage of performance within the range of 1 to 1000% above the performance of the historic comparator(s) and 1 to 99% below the performance of historic comparator(s).
A derivative financial product that is offered for sale at the point of purchase of the underlying asset to which it is associated.
A derivative financial product offered for purchase via a method of payment including credit card payment, debit card payment, guaranteed funds payment, Paypal payment, non-cash loyalty currency, or payment via personal check.
A derivative financial product wherein the cash settlement for the derivative financial product is conducted via refund to the credit card of the purchaser.
A derivative financial product wherein the cash settlement for the derivative financial product is conducted via refund to the debit card of the purchaser.
A derivative financial product wherein the cash settlement for the derivative financial product is conducted via refund to the Paypal account of the purchaser.
A derivative financial product wherein the cash settlement for the derivative financial product is conducted via refund of guaranteed funds to the purchaser.
A derivative financial product wherein the cash settlement for the derivative financial product is conducted via the issuance of a credit redeemable at the original point-of-purchase.
A derivative financial product wherein the cash settlement for the derivative financial product is conducted via refund of non-cash loyalty currency to the purchaser.
A derivative financial product wherein Third Party Data performance for the derivative being offered is displayed concurrent to offering the derivative for sale.
A derivative financial product wherein Third Party Data performance for other derivative financial product(s) is offered concurrent to offering the derivative for sale.
A derivative financial product wherein the point-of-sale retailer is the selling party in the derivative transaction.
A derivative financial product wherein the point-of-sale retailer is a Conduit Vendor in the derivative transaction.
A derivative financial product wherein the point-of-sale retailer offers differential transaction fee conditions dependent on the method of redemption selected by the purchaser.

### Preferred Embodiments

### Example 1

An example of a preferred embodiment of the invention would be an option whose underlying asset is the total unit volume of the retail product CREST® toothpaste based on Third Party Data. In the fall of 2002, a competitor to CREST®, Product X, was expected to launch in the U.S. Product X is expected to be commercially available Nov. 25, 2002. An investor, investor A, was very concerned about the impact product X was going to have on the total unit volume and market share of CREST® in the United States. Investor A purchases one put option on CREST®, which expires Jan. 31, 2003, with an exercise price set to 1,500,000 cumulative units for the month of January 2003. The standard unit of the CREST® unit volume put option is 1/100. If product X, or some other factor, reduces the volume of CREST® used in January 2003 to 1,400,000, then investor A will be able to exercise his option. The payoff will be equal to the difference between the exercise price of the option (1,500,000) and the actual unit volume (1,400,000), or 100,000 times the standard unit of 1/100, or $1000 per contract.

### Example 2

A second example of an application of the present invention would be a future whose underlying asset is the total unit volume of the retail product CREST® toothpaste based on Third Party Data. In the fall of 2002, a competitor to CREST®, Product X, was expected to launch in the U.S. Product X is expected to be commercially available Nov. 25, 2002. An investor, investor A, was very concerned about the impact product X was going to have on the unit volume and market share of CREST® in the United States. Investor A sells one future contract on CREST®, which expires Jan. 31, 2003, with an exercise price set to 1,500,000 cumulative units based on Third Party Data for the month of January 2003. The standard unit of the CREST® unit volume future is 1/100. Because of product X, or some other factor, the actual volume of CREST® used in January 2003 ends up being 1,400,000. At this time, the purchaser of the CREST® future contract would be required to “take delivery” of the future contract from investor A. The settlement of the future contract would be conducted as a payoff, which would be equal to the difference between the exercise price of the future (1,500,000) and the Third Party unit volume (1,400,000), or 100,000 times the contract multiplier of 1/100, or $1000 per contract. Therefore, the seller of the contract, or the short position on the contract (investor A) would be entitled to $1000 from the purchaser of the CREST® unit volume future contract.

### Example 3

A third example of an application of the present invention would be a Point-of-Sale option based on a new Xbox™ video game, titled NBA Live 07. NBA Live 07 is released in September 2006. While purchasing a copy of the game at an outlet for retailer A, John Smith, a 18 year old Xbox game enthusiast, is offered, at the time of check out, the opportunity to purchase from the retail outlet one of three options on the NBA Live 07 game. The three options being offered are pre-arranged to be both mutually exclusive and collectively exhaustive on the performance outcome for NBA Live 07 being measured and tracked as the underlying asset.

The first option, called a Blockbuster™, is structured such that, for each share purchased, if the cumulative unit sales of NBA Live 07 in the U.S. and its territories is greater than 10% above the average of the last 10 new product introductions into the category in which it competes (e.g. home video games) for the first 26 weeks it is available, the purchaser will receive $1.00. Otherwise, (e.g. if the cumulative unit sales is less than or equal to 10% above the average of the last 10 new product introductions into the home video game category), the purchaser will receive nothing upon settlement. The current price being offered for this option by the retailer is $0.31 per share.

The second option, called an Punt™, is structured such that, for each share purchased, if the cumulative unit sales of NBA Live 07 in the U.S. and its territories is less than or equal to 10% above the average and greater than or equal to 90% of the average of the last 10 new product introductions into the category in which it competes (e.g. home video games) for the first 26 weeks it is available, the purchaser will receive $1.00. Otherwise, (e.g. if the cumulative unit sales is greater than 10% above the average or less than 90% of the average of the last 10 new product introductions into the home video game category), the purchaser will receive nothing upon settlement. The current price being offered for this option by the retailer is $0.61 per share.

The third option, called a Bomb™, is structured such that, for each share purchased, if the cumulative unit sales of NBA Live 07 in the U.S. and its territories is less than 90% of the average of the last 10 new product introductions into the category in which it competes (e.g. home video games) for the first 26 weeks it is available, the purchaser will receive $1.00. Otherwise, (e.g. if the cumulative unit sales is greater than or equal to 90% of the average of the last 10 new product introductions into the home video game category), the purchaser will receive nothing upon settlement. The current price being offered for this option by the retailer is $0.10 per share.

Though John Smith is personally buying NBA Live 07 because it prominently features a favorite player of his, he does not think the product will do all that well in general. Therefore, he elects, in addition to his purchase of the game, to purchase 500 shares of the Bomb™ options. In addition to the $0.10 per share price, retailer A also charges a small handling fee depending on how the purchase and payout, in the case the options expire in the money, is handled. The three options retailer A offers are:
1) If the payout is elected to be a refund directly to a credit/debit card, a handling fee of $2.00 or 0.65% of the total option purchase, whichever is greater, is charged.
2) If the purchase and payout is elected to be via guaranteed funds (cash, certified check, money order) redeemable at an outlet of retailer A′s, a handling fee of $1.00 or 0.50% of the total option purchase, whichever is greater, is charged.
3) If the payout is elected as a store credit, regardless of the purchase method, the handling fee is waived.

In this case, John elects to take his potential payout as a cash settlement and purchased 500 shares*$0.10 per share, or $50 total purchase (0.5% of which is $0.25) so the retailer fee is $2.00. Therefore, the total purchase price for John's options are $50.00+$2.00 handling fee=$52.00. This purchase is charged to John's credit card and he is issued, along with his receipt for the Xbox game NBA Live 07, a separate receipt for the purchase of his 500 Bomb™ shares on NBA Live 07. In the case of this example retailer A offered the prices to John Smith based on the quoted prices of the three basic options types for NBA Live 07 from a formal option exchange. At the time of John's purchase, the three basic option types were being quoted at the prices made available to John (e.g. $0.31 per share for Blockbuster™ options, $.61 per share for Punt™ options, and $0.10 per share for Bomb™ options). In the case of this example, retailer A did not have a formal brokerage account to allow for trading of options on the exchange on its own, but has entered into Conduit Vendor relationship for these derivatives. A Conduit Vendor is one where the vendor has entered into a “pass-through” arrangement with the option exchange and the OCC to make options available to customers based on real-time prices quoted from the exchange. The transaction cost the option exchange charged retailer A for this “pass-through” arrangement is $0.50 per trade or 0.25% of the total value of the trade, whichever is greater. Therefore, in the case of this example, retailer A “passed-through” John Smith's option purchase to the exchange, paid $0.50 to the exchange in transactions fees (the greater of $0.50 or 0.25% of $50=$0.125) plus the purchase price of $50.00, or $50.50 total, and collected $52.00 from John, for a net “arbitrage” profit on the transaction of $1.50.

On the formal exchange, at the time of John's option purchase, the prices for the three basic options were $0.31 per share for Blockbuster™ options, $0.61 per share for Punt™ options, and $0.10 per share for Bomb™ options for, in each case, a share worth $1.00. Therefore, the prices for NBA Live 07 reflected the markets assessment at that time that the probability the performance of NBA Live 07 for the first 26 weeks on the market would fall into one of those three categories (which are mutually exclusive and together encompass the totality of all possible outcomes) as a $0.31/$1.00=31% chance that the product would qualify as a Blockbuster™, a $0.61/$1.00=61% chance the product would qualify as an Punt™, and a $0.10/$1.00=10% chance the product would qualify as a Bomb™. Since these three values do not add to 100%, there is inherently an arbitrage opportunity available in the market for NBA Live 07 options at the current prices.

At the time of John's option purchase, another large retailer, retailer B, was very concerned about NBA Live 07. Retailer B had entered into a long-term stocking arrangement with the manufacturer of a competing game to NBA Live 07, was contractually obligated to carrier a significant inventory of the competing game, and was obligated to prominently display the competing game to the exclusion of NBA Live 07. The management of retailer B felt they were over-exposed to the prospects of NBA Live 07 and therefore wanted to hedge their risk on the performance of the product. In order to do so, retailer B went into the open exchange market, where they had an active account with appropriate reserve funds to guarantee their option performance, and took an option position that would hedge their risk if NBA Live 07 performed well (and thus, presumably, the competing game did poorly). In order to do so, the management of retailer B elected to purchase the Punt™ and Blockbuster™ options. In that way, if NBA Live 07 performed well (e.g. at 90% or greater of the average in the category), they would partially offset their lost business opportunity by collecting the in the money payout of the Punt™ and Blockbuster™ options, and if it performed poorly (e.g. below 90% of the average of the category), then they implicitly would perform well by selling a larger amount of the competing product. Therefore, retailer B bought 50,000 shares of Blockbuster™ options at $0.31 per share and 50,000 shares of Punt™ options at $0.61 per share for a total cost to retailer B, sans transaction fees, of $46,000.00

At the time of John Smith's option purchase, a professional options trader, trader Z, who followed the video game options market, noticed that an imbalance existed in the prices for the three options on NBA Live 07. Since the ultimate outcome of the performance of NBA Live 07 has to fall within the criteria for one of the options (e.g. the criteria for the three options; greater than 110%, less than or equal to 110%, but greater than or equal to 90%, less than 90% are collectively exhaustive or cover the entire range of potential outcomes) the prices, and therefore implicit probabilities of each outcome, should theoretically add up to 100%. Since the prices at the time of John Smith's purchase were $0.31, $0.61, and $0.10 respectively for the Blockbuster™, Punt™, and Bomb™ options, totaling $1.02, trader Z stepped into the market to take advantage of the arbitrage opportunity available. Trader Z sold the 50,000 shares of Blockbuster™ and Punt™ options purchased by retailer B for $0.31 per share and $0.61 per share respectively and then sold on the open market 50,000 share of Bomb™ options for $0.10 per share (500 of which were purchased by John Smith), which netted for trader Z a total proceeds of ($0.31 *50,000+$0.61*50,000+$0.10*50,000=$51,000).

Six months later, the data from Rentrak Corporation shows that NBA Live 07 sold 152,000 units in the U.S. and its territories in its first 26 weeks on the market. The Rentrak data also indicates that the last 10 entries into the home video game category sold, on average, 173,000 units in their first 26 weeks on the market. Therefore, NBA Live 07 sold 152,000/173,000=87.9% of the unit volume of the average, which is less than 90% of the average of the last 10 new product introductions into the category. Therefore, John Smith's options have expired in the money, and are now worth $1.00/share. John elected to have his potential payout be refunded directly to his credit card. Trader Z, as the ultimate seller of these 500 options to John, pays out $500 to the option exchange which, upon prior arrangement with the retailer and the credit card merchant, refunds the $500 to John Smith's credit card account.

As the three options offered on NBA Live 07 are mutually exclusive, by definition the Blockbuster™ and Punt™ options have expired out of the money. The hedge Retailer B took, which was to purchase 50,000 shares of each of these options, has worked and they have sold a large amount of the competing video game. However, they are out the $46,000 they used to protect themselves in the case of a strong performance of NBA Live 07.

Trader Z received $51,000 in proceeds by selling 50,000 shares of each of the three options in this example on NBA Live 07. The Bomb™ options trader Z sold are now worth $1.00 per share, and so trader Z must settle these options with the buyers (which includes the 500 shares purchased by John Smith). Therefore, trader Z must pay out a total 50,000 shares*$1.00 per share=$50,000 at the time of settlement. However, since the other options trader Z sold (the 50,000 shares of Blockbuster™ and Punt™) have expired out of the money, no further payouts are required of trader Z and therefore he keeps the originally identified arbitrage profit of his options sales proceeds ($51,000) less his payouts ($50,000) or $1,000.

### Example 4

A fourth example of an application of the present invention would be a point of sale option purchased at a movie box office ticket counter based on a newly released movie, Devon and Kendall's Excellent Adventure (DAKEA). DAKEA is an action adventure film that will premier in theaters across the country on Thanksgiving day. Milo, a twenty year old college freshman majoring in business, is taking his girlfriend, Natasha, out to the movies to see DAKEA. At the box office ticket counter Milo has purchased two tickets for the evening and is also presented with the opportunity purchase options based on the performance of box office ticket sales as determined by a nationally syndicated third party data source such as Rentrak.

The first option Milo can purchase is called a Blockbuster™, and is structured such that for each share purchased, if the cumulative box office ticket sales for the movie DAKEA in the U.S. and its territories is greater than 10% above the average of the last 10 movie premiers into the category it competes in (e.g. action movies) for the first 12 weeks after the movie premier, the purchaser will receive $1.00. If Milo purchases a Blockbuster™ option against the movie category and if the cumulative unit sales is less than or equal to 10% above the average of the last 10 movie premiers in the movie category, the Milo will receive nothing upon settlement. The current price being offered for this option by the box office retailer is $0.31 per share.

The second option Milo can purchase is called a Punt™, and is structured such that, for each share purchased, if the cumulative box office ticket sales for the movie DAKEA in the U.S. and its territories is less than or equal to 10% above the average and greater than or equal to 90% of the average ticket sales of the last 10 movie premiers into the category it competes in (e.g. action movies) for the first 12 weeks after the movie premier, the purchaser will receive $1.00. Otherwise, (e.g. if the cumulative box office ticket sales is greater than 10% above the average or less than 90% of the average of the last 10 movie premiers into the action movie category over the first 12 week after the movie is released) the purchaser will receive nothing upon settlement. The current price being offered for this option by the box office retailer is $0.61 per share.

The third option Milo can purchase is called a Bomb™ and is structured such that, for each share purchased, if the cumulative box office ticket sales for the movie DAKEA in the U.S. and its territories is less than 90% of the average of the last 10 movie premiers into the category it competes in (e.g. action movies) for the first 12 weeks after the movie premier, the purchaser will receive $1.00. Otherwise, (e.g. if the cumulative unit sales is greater than or equal to 90% of the average of the last 10 movie premiers into the category it competes in (e.g. action movies) for the first 12 weeks after the movie premier), the purchaser will receive nothing upon settlement. The current price being offered for this option by the box office retailer is $0.08 per share.

Milo and Minnie both believe the movie DAKEA is going to perform average compared to other action movies. Therefore, Milo elects to purchase 500 shares of the Punt™ options in addition to his purchase of the theater tickets to see DAKEA. In addition to the $0.61 per share price, retailer A also charges a small handling fee depending on how the purchase and payout, in the case the options expire in the money, is handled. The three options the box office retailer offers are:
1. If the payout is elected to be a refund directly to a credit/debit card, a handling fee of $2.00 or 0.65% of the total option purchase, whichever is greater, is charged.
2. If the purchase and payout is elected to be via guaranteed funds (cash, certified check, money order) redeemable at an outlet of retailer A's, a handling fee of $1.00 or 0.50% of the total option purchase, whichever is greater, is charged.
3. If the payout is elected as a store credit, regardless of the purchase method, the handling fee is waived.

In this case, Milo elects to take his potential payout via guaranteed funds and purchased 500 shares * $0.61 per share, or $61 for the options plus a handling fee of $1.00 (the greater of 0.5% of $61 or $1.00). Therefore, the total purchase price for Milo's options are $61.00+$1.00 handling fee=$62.00. Milo purchases the tickets and his options in cash and is issued, along with his receipt for the DAKEA movie tickets, a separate receipt for the purchase of his 100 Blockbuster™ shares on DAKEA.

In the case of this example the box office theater offered the prices to Milo based on the quoted prices of the three basic option types for the movie premier of DAKEA from a formal option exchange. At the time of Milo's purchase, the three basic option types were being quoted at the prices made available to Milo (e.g. $0.31 per share for Blockbuster™ options, $.61 per share for Punt™ options, and $0.08 per share for Bomb™ options). In the case of this example, the box office theater did not have a formal brokerage account to allow for trading of options on the exchange on its own, but has entered into Conduit Vendor relationship for these derivatives. A Conduit Vendor is one where the vendor has entered into a “pass-through” arrangement with the option exchange and the OCC to make options available to customers based on real-time prices quoted from the exchange. The transaction cost the option exchange charged the box office retailer for this “pass-through” arrangement is $0.50 per trade or 0.25% of the total value of the trade, whichever is greater. Therefore, in the case of this example, the box office theater “passed-through” Milo's option purchase to the exchange, paid $0.50 to the exchange in transactions fees (the greater of $0.50 or 0.25% of $61) plus the purchase price of $61.00, or $61.50 total, and collected $62.00 from Milo, for a net “arbitrage” profit on the transaction of $0.50.

Six months later, the data from Rentrak Corporation shows that Devon and Kendall's Excellent Adventure (DAKEA) sold 1,520,000 tickets in the U.S. and its territories in its first 12 weeks after the movie premier. The Rentrak data also indicates that the last 10 premiers in the action movie category sold, on average, 1,273,000 tickets in their first 12 weeks on the market. Therefore, DAKEA sold 1,520,000/1,273,000=119.4% of the unit volume of the average, which is greater than 110% of the average of the last 10 new product introductions into the category. Therefore, Milo's options have expired out of the money, and are now worthless.

### Example 5

A father, Frank, overhears her daughter, Candice, talking to one of her friends about new jeans by the Zen line of clothing (Zen's Fall '07 jeans) that will debut at a fashion show in New York City. Frank asks her daughter about the popularity of Zen jeans and she mentions the Zen line of clothing is a very popular brand among females and that the new jeans will become “all the rage” within female pop culture. Frank becomes interested in his daughter's comments on these consumer jeans and follows up with some financial research on Zen Inc. Frank finds that Zen Inc. is a small, private company, leaving him with little opportunity to leverage his knowledge in the classic stock and options market. However, point-of-sale options on the Zen's Fall '07 jeans are available. Therefore, Frank decides he would like to purchase point-of-sale options on the success of Zen's Fall '07 jeans as determined by a nationally syndicated third party data source such as Information Resources Inc. (IRI).

Three options are available to Candice's father, a Blockbuster™, Punt™, and a Bomb™ and would be would be structured in a similar manner and have similar payouts as described in Example 3.

In the instance of Example 5, the three options would be benchmarked against an intangible underlying asset of unit sales data of Zen jeans provided by IRI where the payout thresholds for each option would be described as follows:
1. For the Blockbuster™ option, a payout would occur if unit sales after 24 weeks exceed 10% of the average of the last 4 product introductions in female high fashion jeans category.
2. For the Punt™ option, a payout would occur if unit sales after 24 weeks are less than or equal to 10% above the average of the last 4 product introductions in female high fashion jeans category and greater than or equal to 90% of the average of the last 4 product introductions in female high fashion jeans category.
3. For the BOMB™ option, a payout would occur if unit sales after 24 weeks are less than 90% of the average of the last 4 product introductions in female high fashion jeans category.

In this example the time to expiry for the Blockbuster™, Punt™, and a Bomb™ options is 24 weeks after the release into retail clothing outlets.

Frank decides to purchase this option at the customer service desk of a well known department store that carries Zen Inc. clothing line via credit card. He does not purchase a pair of jeans but simply wants to purchase a Punt™ option based on his research on Zen Inc.

The cumulative sales for the fall '07 jean release from Zen Inc. yielded sales that were 104% of sales versus the historic comparators, meeting the payout requirements for a Punt™ option. Frank returned to the department store to collect on his payout and selected to receive his payout via a credit towards his credit card that was used to purchase the options initially.

### Example 6

FOXY Studios is promoting a new winter show, DOGFIGHT. FOXY Studios indicates that DOGFIGHT will air 13 original episodes (and fill in with re-runs) throughout the fall season. Connie, who is a producer at a competitive studio, WBBS, has her own new program scheduled during the same time slot as DOGFIGHT. After collecting some competitive intelligence, Connie believes DOGFIGHT has promising potential in garnering a following of loyal television viewers. Connie wants to hedge the return of her program during the fall of 2007 due to overlapping on-air times (both show are to air on Thursday's at 8 pm) by purchasing options on the success of DOGFIGHT as determined by a nationally syndicated third party data source such as the Nielsen Television Index Ranking Report, from Nielsen Media Research.

Three options are available to Connie, a Blockbuster™, Punt™, and a Bomb™ and would be would be structured in a similar manner and have similar payouts as described in Example 3.

In the instance of Example 6, the three options would be benchmarked against an intangible underlying asset of Nielsen Television Ratings data of DOGFIGHT provided by Nielsen Media Research where the payout thresholds for each option would be described as follows:
1. For the Blockbuster™ option, a payout would occur if the Nielsen rating of DOGFIGHT at the close of the following Nielsen Sweeps time frame (eg. Nielsen Sweeps Nov. 1-Nov. 28, 2007) was 10% greater than the average Nielsen rating for all Thursday 8 pm television show airings during the prior Nielsen Sweeps time frame (Nielsen Sweeps from Jul. 5-Aug. 1, 2007).
2. For the Punt™ option, a payout would occur if the Nielsen rating of

DOGFIGHT at the close of the following Nielsen Sweeps time frame (e.g. Nielsen Sweeps Nov. 1-Nov. 28, 2007) is less than or equal 10% above the average Nielsen rating for all Thursday 8 pm television show airings during the Nielsen Sweeps time frame prior to the season opening broadcast of DOGFIGHT. (eg. Nielsen sweeps from Jul. 5-Aug. 1, 2007 if DOGFIGHT premiers Aug. 16, 2007) and greater than or equal to 10% below the average Nielsen rating for all Thursday 8 pm television show airings during the Nielsen Sweeps time frame prior to the season opening broadcast of DOGFIGHT. (eg. Nielsen sweeps from Jul. 5-Aug. 1, 2007 if DOGFIGHT premiers Aug. 16, 2007).
3. For the BOMB™ option, a payout would occur if the Nielsen rating of

DOGFIGHT at the close of the following Nielsen Sweeps time frame (eg. Nielsen Sweeps Nov. 1-Nov. 28, 2007) is less than 10% below the average Nielsen rating for all Thursday 8 pm television show airings during the Nielsen Sweeps time frame prior to the season opening broadcast of DOGFIGHT. (eg. Nielsen sweeps from Jul. 5-Aug. 1, 2007 if DOGFIGHT premiers Aug. 16, 2007).

The time to expiry for the Blockbuster™, Punt™, and a Bomb™ options in this example would be the end of the November sweep, or Nov. 28, 2007. Below are the quarterly Nielsen Sweeps time frames for 2007:

Nielsen 2007 Sweeps Dates:

| | |
|---|---|
| February 2007 | Feb. 1-Feb. 28, 2007 |
| May 2007 | Apr. 26-May 23, 2007 |
| July 2007 | Jul. 5-Aug. 1, 2007 |
| November 2007 | Nov. 1-Nov. 28, 2007 |

After the debut of DOGFIGHT and assessing her competitive intelligence, Connie makes a call to the finance department each week for the entire first season to purchase Blockbuster™ options for DOGFIGHT through the company corporate account.

Though popular, the Nielsen ratings for DOGFIGHT at the end of the November sweeps was only 8% above the average Nielsen rating for all Thursday 8 pm television show airings during the prior July 2007 Nielsen Sweeps time frame. As a result Connie's Blockbuster™ options on DOGFIGHT were worthless for the first season.

### Example 7

Sarah, a college student, is an avid follow of pop music sensation, Jerald Riverlake. His first album went platinum and the record produced 3, #1 singles on the Billboard music charts. Jerald Riverlake is coming out with his second album in Fall. The debut single from his second album, I Wish, is expected to become a number #1 hit. When the album is available in record stores, Sarah is first in line, to purchase Jerald's second album, JR Part II. At the record store Sarah is also presented an opportunity to purchase an option on the song title I Wish.

Three options are available to Sarah, a Blockbuster™, Punt™, and a Bomb™ and would be would be structured in a similar manner and have similar payouts as described in Example 3.

The three options would be benchmarked against an intangible underlying asset of Radio and Records National Airplay Charts of airplay data and song rankings provided by Nielsen Broadcast Data Systems. The ranking of song titles are based on cumulative number of airplays at radio stations in a given week. The song with the most radio station airplay is ranked #1; the song with the next greatest number of airplay is ranked #2, etc. The payout thresholds for each option would be described as follows:
1. For the Blockbuster™ option, a payout would occur if the number of weeks that “I Wish” placed on the top 20 R&R airplay rankings over 20 weeks from first release was greater than 2 weeks above the average number of weeks in the top 20 for the last 10 songs by male pop artists on the Radio & Records (R&R) music charts (for aiplay) over a 20 week time horizon.
2. For the Punt™ option, a payout would occur if the number weeks that “I Wish” placed on the top 20 R&R airplay rankings from first release was less than or equal to 2 weeks above the average number of weeks in the top 20 for the last 10 songs by male pop artists on the Radio & Records (R&R) music charts (for airplay) over a 20 week time horizon and greater than or equal to 2 weeks below than the average number of weeks in the top 20 for the last 10 songs by male pop artists on the Radio & Records (R&R) music charts (for airplay) over a 20 week time horizon.
3. For the BOMB™ option, a payout would occur if the number weeks that “I Wish” placed on the top 20 R&R airplay rankings from first release was less than to 2 weeks below than the average number of weeks in the top 20 for the last 10 songs by male pop artists on the Radio & Records (R&R) music charts (for airplay) over a 20 week time horizon.

The time to expiry for the Blockbuster™, Punt™, and a Bomb™ options would be 20 weeks from the first release of I Wish.

Sarah decides to purchase 50 Blockbuster™ option for song title I Wish at the record store as she purchases her the new Jerald Riverlake album. During the point of purchased, the average number of weeks on the R&R′s top 20 for the last 10 songs by male pop artists over 20 weeks was 7 weeks. Over the course of 20 weeks from release, Jerald Riverlake's, “I Wish”, was in the top 20 R&R ranking for airplay for 12 weeks, thus satisfying the payoff threshold for the Blockbuster options. As a result Sarah earns a payout of $50 (given the options were created in a similar fashion with those described in Example 5.). Sarah elected to collect her payout as a credit towards her credit card used to purchase the option.

Note on Scope of Invention

There are numerous ways the underlying asset of a retail derivative financial product can be based on Third Party Data of a Retail Product or Products, including trans-category derivatives (e.g. derivatives that measure the performance of a variety of Retail Products with a common denominator, such as all Retail Products, including merchandise, associated with a particular movie or actor). Furthermore, there are also numerous scenarios and locales (e.g. Europe, Asia) under which the measurement, buying, and selling of these financial products could be conducted. The above descriptions and preferred embodiments are examples only and are in no way intended to limit the potential combinations, scenarios, locales, customers, etc. with which the present invention could be utilized.

Finally, specific data providers are shown as examples only, and are not exhaustive of the number or types of Third Party Data providers.

Note also that the idea of constructing financial products where the value of the product is related to performance indicators for Retail Products can be applied beyond the scope of the present invention to include tracking stocks and other sub-divided equity products such as dividend equity strips described by Whitworth in US Application 2002/0161684 and its associated prior art.

### REFERENCES

U.S Patent Documents

| | | |
|---|---|---|
| 7,006,991 | Feb. 28, 2006 | Keiser et al. |
| 6,505,174 | Jan. 7, 2003 | Keiser et al. |
| 5,950,176 | Sep. 7, 1999 | Keiser et al. |

U.S. Patent Applications

| | | |
|---|---|---|
| 20040153375 | Aug. 5, 2004 | Mukunya et al. |
| 10/358,647 | Feb. 5, 2003 | Sippy et al. |
| 20020161684 | Oct. 31, 2002 | Whitworth, Brian L. |

### OTHER REFERENCES

Active Worlds (www.activeworlds.com)

Arbitron (www.arbitron.com)

ComScore Networks (www.comscore.com)

Exhibitor Relations (www.ercboxoffice.com)

Hollywood Stock Exchange, (www.hsx.com)

Iowa Electronic Markets (www.biz.uiowa.edu)

IRI (www.infores.com)

Nielsen BDS (www.bdsradio.com)

Nielsen EDI (www.entdata.com)

Nielsen Media Research (www.nielsenmedia.com)

Paypal Inc. (www.x.com)

Promosquad (www.promosquad.com)

Radio & Records (www.radioandrecords.com)

Rentrak (www.rentrak.com).

Second Life (www.secondlife.com)

ComScore Press Release, “U.S. Online Apparel Spending Grows 32 Percent in the Third Quarter versus Year Ago,” (Nov. 16, 2006)

Coyle, J., “Movie Openings: Behind the Box Office,” Associated Press (Aug. 2, 2006)

Kelly, K., “Defying the Odds, Hedge Funds Bet Billions on Movies” Wall Street Journal, (Apr. 29, 2006), page A1.

Reuters, “Nielsen to track TC viewing on Web, mobile phones,” (Jun. 18, 2006)

Wall Street Journal, “At the Box Office,” (Nov. 20, 2006), page B8

We claim:

1. A derivative financial product comprising: An underlying asset based on a Third-Party Data performance indicator of one or more Retail Product(s), an exercise price based on said underlying asset, a standard unit for said underlying asset, and a time of expiration for said combination of said underlying asset, said standard unit and said exercise price.

2. A derivative financial product as in claim 1, wherein the Third Party Data performance indicator is a ratio of unit volume to historic comparables of one or more Retail Product(s).

3. A derivative financial product as in claim 2, wherein the exercise price is based on the Third Party Data performance indicator reaching a pre-determined level of performance relative to historic comparator(s).

4. A combination of derivative financial products from claim 2 where the pre-determined levels of performance for the common Retail Product are established such that the derivative financial products are mutually exclusive.

5. A combination of derivative financial products from claim 2 where the pre-determined levels of performance for the common Retail Product are established such that the derivative financial products are collectively exhaustive.

6. A combination of derivative financial products from claim 2 where the pre-determined levels of performance for the common Retail Product are established such that the derivative financial products are both mutually exclusive and collectively exhaustive.
